(19) United States
(12) Patent Application Publication
(10) Pub. No.: US 2012/0072497 A1
(43) Pub. Date: Mar. 22, 2012

(54) SOCIAL INTERACTION APPLICATION

(76) Inventor: Dak Brandon Steiert, Edwards, CO (US)

(21) Appl. No.: 13/231,834

(22) Filed: Sep. 13, 2011

Related U.S. Application Data
(60) Provisional application No. 61/384,845, filed on Sep. 21, 2010.

(51) Int. Cl. G06F 15/16

(52) U.S. Cl. 709/204

(57) ABSTRACT

The social application of the first preferred embodiments includes selecting a group of users from a pool of users using an automatic selection algorithm or a combination of an automatic selection algorithm and a user driven process and putting the selected group of users into a game or putting the selected group of users into a group activity. The social application of the preferred embodiments is designed to give people an entertaining and structured way to interact, help people meet other people, give people a fun diversion, or any combination of these. The social application of the preferred embodiments may be a website, another application that uses the internet, or any other suitable form of networked application. The social application of the preferred embodiments may, however, be used for any suitable purpose, in any suitable way and with any suitable method of including users.

### CROSS-REFERENCE TO RELATED APPLICATIONS

This application is a non-provisional continuation of U.S. Provisional Patent Application Ser. No. 61/384,845 filed on Sep. 21, 2010 (Sep. 21, 2010), and entitled “SOCIAL INTERACTION APPLICATION”, the priority of which is claimed by this application, and the entire contents and substance of which are hereby incorporated in total by reference.

### BRIEF DESCRIPTION OF THE FIGURES

FIG. 1a is a schematic representation of the system of the first preferred embodiment wherein the users participate in a game.

FIG. 1b is a schematic representation of the system of the first preferred embodiment wherein the users participate in a group activity.

FIG. 2a is a schematic representation of the system of the first preferred embodiment wherein the automatic selection algorithm takes into account at least one of: (a) how a user plays at least one game; (b) information submitted by a user; (c) at least one answer a user gives to at least one question; (d) at least one personal interest a user submits; (e) at least two words a user has input into the social application; (f) at least one other user that a user submits that they like; (g) at least one other user that a user submits that they dislike; (h) feedback a user submits about at least one other user; (i) at least one test taken by a user; (j) information on at least one other user a user interacts with more frequently than other users.

FIG. 2b is a schematic representation of the system of the first preferred embodiment wherein the automatic selection algorithm takes into account at least one of: (a) how a user plays at least one game; (b) information submitted by a user; (c) at least one answer a user gives to at least one question; (d) at least one personal interest a user submits; (e) at least two words a user has input into the social application; (f) at least one other user that a user submits that they like; (g) at least one other user that a user submits that they dislike; (h) feedback a user submits about at least one other user; (i) at least one test taken by a user; (j) information on at least one other user a user interacts with more frequently than other users.

FIG. 3 is a schematic representation of the system of the first preferred embodiment wherein the at least one group activity includes at least one of: (a) at least part of the group of users cooperating to achieve an outcome; (b) at least part of the group of users cooperating to participate in at least one of (I) a creative activity and (II) the generation of a creative work; (c) competition between the users in at least part of the group of users; (d) at least part of the group of users cooperating to at least one of (III) solve a problem and (IV) overcome a problem; (e) competition between the users in at least part of the group of users to at least one of (V) solve a problem and (VI) overcome a problem; and (f) participation of at least part of the group of users in a conversation that is at least partially guided.

FIG. 4a is a schematic representation of the system of the first preferred embodiment wherein the automatic selection algorithm comprises creating a rating of how many traits users have in common and taking into account the rating to select a group of users from the pool of users.

FIG. 4b is a schematic representation of the system of the first preferred embodiment wherein the automatic selection algorithm comprises creating a rating of how many traits users have in common and taking into account the rating to select a group of users from the pool of users.

FIG. 5a is a schematic representation of the system of the first preferred embodiment wherein the activity of users using the social application is tracked and a group of users from the pool of users is selected taking into account at least one of (a) words a user uses, (b) other users a user submits that they like, (c) other users a user submits that they dislike, (d) feedback a user gives about other users, and (e) other users that a user interacts with most.

FIG. 5b is a schematic representation of the system of the first preferred embodiment wherein the activity of users using the social application is tracked and a group of users from the pool of users is selected taking into account at least one of (a) words a user uses, (b) other users a user submits that they like, (c) other users a user submits that they dislike, (d) feedback a user gives about other users, and (e) other users that a user interacts with most.

FIG. 6a is a schematic representation of the system of the first preferred embodiment wherein the activity of users using the social application is tracked and the system makes a judgment on the probability a user will at least one of (a) like another user, (b) enjoy interacting with another user, (c) dislike interacting with another user, (d) not enjoy interacting with another user, (e) enjoy playing games with another user, and (f) not enjoy playing games with another user, and a group of users is selected from the pool of users using this probability judgment.

FIG. 6b is a schematic representation of the system of the first preferred embodiment wherein the activity of users using the social application is tracked and the system makes a judgment on the probability a user will at least one of (a) like another user, (b) enjoy interacting with another user, (c) dislike interacting with another user, (d) not enjoy interacting with another user, (e) enjoy playing games with another user, and (f) not enjoy playing games with another user, and a group of users is selected from the pool of users using this probability judgment.

FIG. 7a is a schematic representation of the system of the first preferred embodiment wherein the automatic selection algorithm comprises creating a rating of how many traits users have in common and selecting a group of users from the users that fall within a selected range of commonality ratings.

FIG. 7b is a schematic representation of the system of the first preferred embodiment wherein the automatic selection algorithm comprises creating a rating of how many traits users have in common and selecting a group of users from the users that fall within a selected range of commonality ratings.

FIG. 8a is a schematic representation of the system of the first preferred embodiment wherein the activity of users using the social application is tracked and the system makes a judgment on the probability a user will at least one of (a) like another user, (b) enjoy interacting with another user, (c) dislike interacting with another user, (d) not enjoy interacting with another user, (e) enjoy playing games with another user, and (f) not enjoy playing games with another user and a group of users is selected from the users that fall within a selected range of the judged probability.

FIG. 8b is a schematic representation of the system of the first preferred embodiment wherein the activity of users using the social application is tracked and the system makes a judgment on the probability a user will at least one of (a) like another user, (b) enjoy interacting with another user, (c) dislike interacting with another user, (d) not enjoy interacting with another user, (e) enjoy participating in group activities with another user, and (f) not enjoy participating in group activities with another user and a group of users is selected from the users that fall within a selected range of the judged probability.

FIG. 9a is a schematic representation of the system of the first preferred embodiment wherein the activity of users using the social application is tracked and the system makes a judgment on the probability a user will at least one of (a) like another user, (b) enjoy interacting with another user, (c) dislike interacting with another user, (d) not enjoy interacting with another user, (e) enjoy playing games with another user, and (f) not enjoy playing games with another user, wherein the automatic selection algorithm further comprises creating a rating of how many traits users have in common, and a group of users is selected from the pool of users by choosing from users that both fall within a selected range of commonality ratings and a selected range of judged probabilities.

FIG. 9b is a schematic representation of the system of the first preferred embodiment wherein the activity of users using the social application is tracked and the system makes a judgment on the probability a user will at least one of (a) like another user, (b) enjoy interacting with another user, (c) dislike interacting with another user, (d) not enjoy interacting with another user, (e) enjoy participating in group activities with another user, and (f) not enjoy participating in group activities with another user, wherein the automatic selection algorithm further comprises creating a rating of how many traits users have in common, and a group of users is selected from the pool of users by choosing from users that both fall within a selected range of commonality ratings and a selected range of judged probabilities.

FIG. 10a is a schematic representation of the system of the first preferred embodiment wherein users are placed in a game and allowed to play the game for a period of time before they are allowed to have private side conversations with one another, in addition to the whole group conversation.

FIG. 10b is a schematic representation of the system of the first preferred embodiment wherein users are placed in a group activity and allowed to participate in the group activity for a period of time before they are allowed to have private side conversations with one another, in addition to whole group conversation.

FIG. 11a is a schematic representation of the system of the first preferred embodiment wherein after a period of time users who have been interacting with one another are asked if they would like to exchange contact information with each other.

FIG. 11b is a schematic representation of the system of the first preferred embodiment wherein after a period of time users who have been interacting with one another are asked if they would like to exchange their contact information with each other.

FIG. 12a is a schematic representation of the system of the first preferred embodiment wherein a game is chosen from a pool of different game options.

FIG. 12b is a schematic representation of the system of the first preferred embodiment wherein a group activity is chosen from a pool of different group activity options.

FIG. 13a is a schematic representation of the system of the first preferred embodiment wherein users input a preference for the type of game they would like to play and a game is then chosen from a pool of different game options.

FIG. 13b is a schematic representation of the system of the first preferred embodiment wherein users input a preference for the type of group activity they would like to participate in and a group activity is then chosen from a pool of different group activity options.

FIG. 14a is a schematic representation of the system of the first preferred embodiment wherein users can submit at least one of rankings and ratings for other users they interact with.

FIG. 14b is a schematic representation of the system of the first preferred embodiment wherein users can submit at least one of rankings and ratings for other users they interact with.

FIG. 15a is a schematic representation of the system of the second preferred embodiment wherein at least one of a website, a networked application and a social website at least one of includes and provides a social application wherein the group of users participate in a game.

FIG. 15b is a schematic representation of the system of the second preferred embodiment wherein at least one of a website, a networked application and a social website at least one of includes and provides a social application wherein the group of users participate in a group activity.

FIG. 16a is a schematic representation of the system of the second preferred embodiment wherein the automatic selection algorithm takes into account at least one of: (a) how a user plays at least one game; (b) information submitted by a user; (c) at least one answer a user gives to at least one question; (d) at least one personal interest a user submits; (e) at least two words a user has input into the social application; (f) at least one other user that a user submits that they like; (g) at least one other user that a user submits that they dislike; (h) feedback a user submits about at least one other user; (i) at least one test taken by a user; (j) information on at least one other user a user interacts with more frequently than other users.

FIG. 16b is a schematic representation of the system of the second preferred embodiment wherein the automatic selection algorithm takes into account at least one of: (a) how a user plays at least one game; (b) information submitted by a user; (c) at least one answer a user gives to at least one question; (d) at least one personal interest a user submits; (e) at least two words a user has input into the social application; (f) at least one other user that a user submits that they like; (g) at least one other user that a user submits that they dislike; (h) feedback a user submits about at least one other user; (i) at least one test taken by a user; (j) information on at least one other user a user interacts with more frequently than other users.

FIG. 17 is a schematic representation of the system of the second preferred embodiment wherein the at least one group activity includes at least one of: (a) at least part of the group of users cooperating to achieve an outcome; (b) at least part of the group of users cooperating to participate in at least one of (I) a creative activity and (II) the generation of a creative work; (c) competition between the users in at least part of the group of users; (d) at least part of the group of users cooperating to at least one of (III) solve a problem and (IV) overcome a problem; (e) competition between the users in at least part of the group of users to at least one of (V) solve a problem and (VI) overcome a problem; and (f) participation of at least part of the group of users in a conversation that is at least partially guided.

FIG. 18a is a schematic representation of the system of the second preferred embodiment wherein at least one game is chosen from a pool of game options, wherein at least one of the games in the pool of at least two different game options is at least one of (a) chosen, (b) adapted, and (c) designed to achieve at least one goal, wherein the at least one goal comprises at least one of: (aa) encourage at least one of the users to interact with at least one of the other users; (bb) enable at least one of the users to get to know at least one of the other users; (cc) make at least one interaction between at least one of the users and at least one of the other users more enjoyable for at least one of the users in the interaction; and (dd) enable at least one of the users to meet at least one other user that the at least one user had not met before.

FIG. 18a is a schematic representation of the system of the second preferred embodiment wherein at least one group activity is chosen from a pool of group activity options, wherein at least one of the group activities in the pool of at least two different group activity options is at least one of (a) chosen, (b) adapted, and (c) designed to achieve at least one goal, wherein the at least one goal comprises at least one of: (aa) encourage at least one of the users to interact with at least one of the other users; (bb) enable at least one of the users to get to know at least one of the other users; (cc) make at least one interaction between at least one of the users and at least one of the other users more enjoyable for at least one of the users in the interaction; and (dd) enable at least one of the users to meet at least one other user that the at least one user had not met before.

### DESCRIPTION OF THE PREFERRED EMBODIMENTS

The following description of the preferred embodiments of the invention is intended to enable someone skilled in the prior art to make and use this invention, but is not intended to limit the invention to these preferred embodiments.

### 1. First Preferred Embodiment

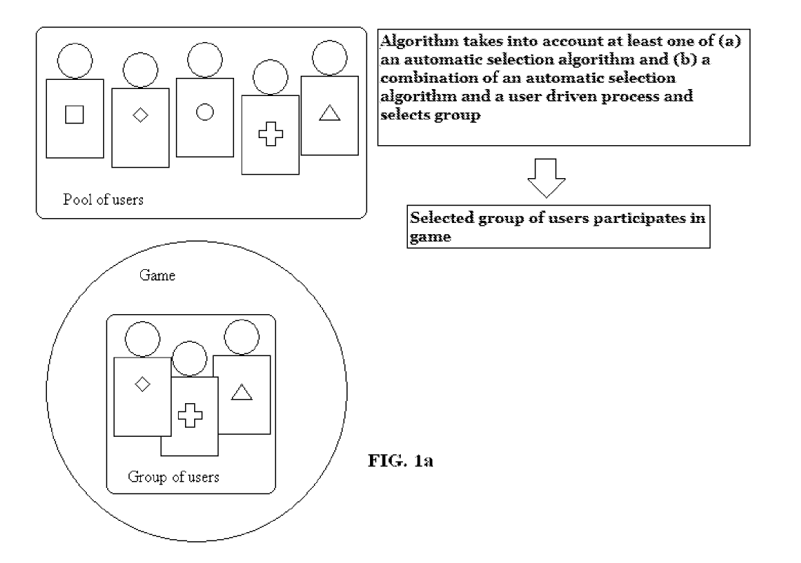

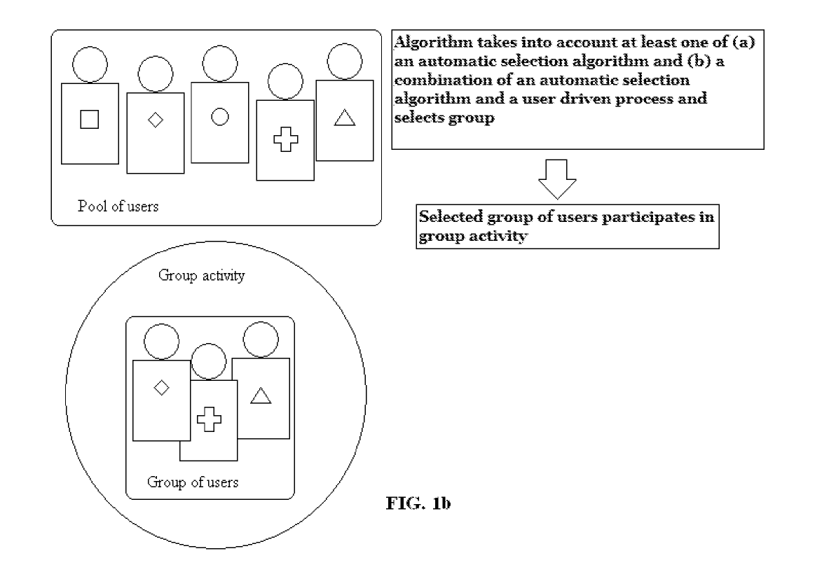

As shown in FIGS. 1a and 1b, the social application of the first preferred embodiments includes selecting a group of users from a pool of users using an automatic selection algorithm or a combination of an automatic selection algorithm and a user driven process and putting the selected group of users into a game, as shown in FIG. 1a, or putting the selected group of users into a group activity, as shown in FIG. 1b. The social application of the preferred embodiments is designed to give people an entertaining and structured way to interact, help people meet other people, give people a fun diversion, or any combination of these. The social application of the preferred embodiments may be a website, another application that uses the internet, or any other suitable form of networked application. The social application of the preferred embodiments may, however, be used for any suitable purpose, in any suitable way and with any suitable method of including users.

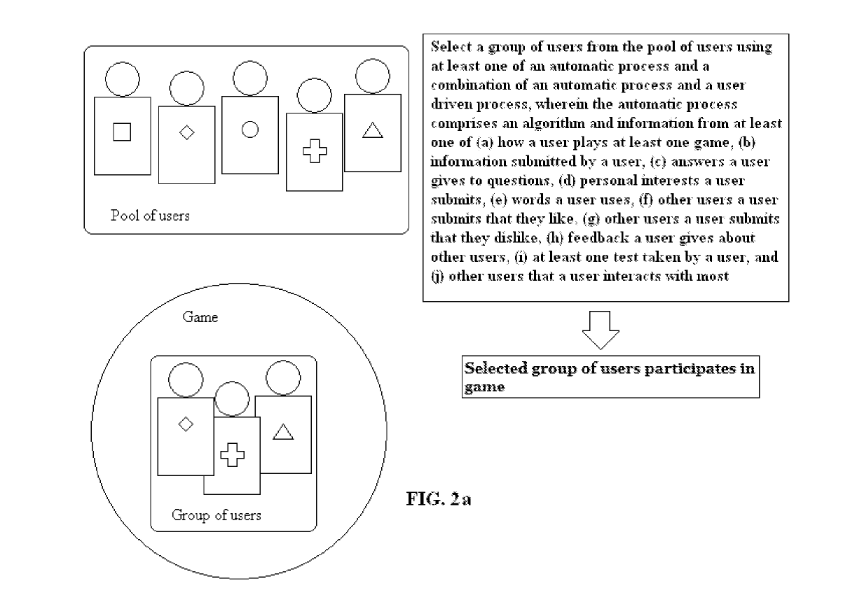

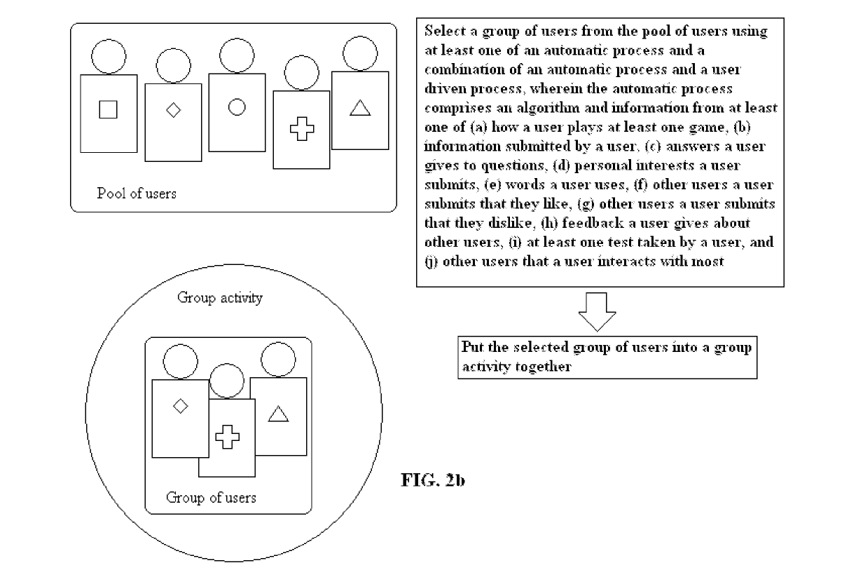

As shown in FIGS. 2a and 2b, the automatic selection algorithm of the first preferred embodiment preferably takes into account at least one of: how a user plays at least one game; information submitted by a user; at least one answer a user gives to at least one question; at least one personal interest a user submits; at least two words a user has input into the social application; at least one other user that a user submits that they like; at least one other user that a user submits that they dislike; feedback a user submits about at least one other user; at least one test taken by a user; information on at least one other user a user interacts with more frequently than other users. The automatic selection algorithm preferably uses at least one of these pieces of information to select a group of users that is well suited to achieving positive interactions between users and interactions that suit the goals of the system of the first preferred embodiment. The automatic selection algorithm may, however, take into account any suitable information or characteristics when selecting which users to put into the group of users. Furthermore, the automatic selection algorithm may, however, use the pieces of information it takes into account to select any group of users that satisfy any suitable requirements. The selected group of users is then either placed into a game as shown in FIG. 2a or into a group activity as shown in FIG. 2b. Users are preferably given one or more of: a question or series of questions; a game or games to play, preferably short games; a form or other structure to submit information about themselves or other information relevant to them; a form or other structure to submit their personal interests; or one or more tests. One or more of these are preferably given when the user either signs up to use the social application or first uses the social application, while any of the others can be given to the user at any suitable point. Information or characteristics of the user may, however, be obtained by any suitable manner and at any suitable time.

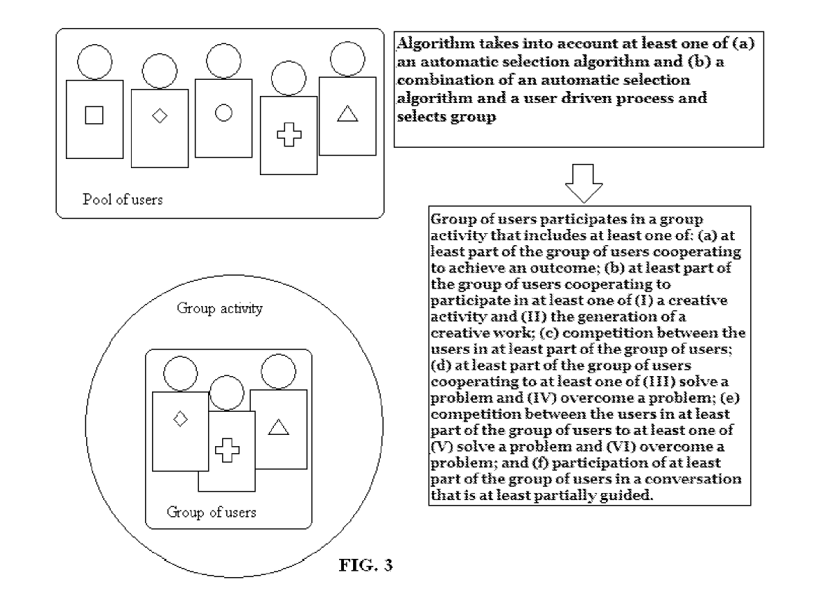

As shown in FIG. 3, the group activity of the first preferred embodiment preferably includes one or more of: at least part of the group of users cooperating to achieve an outcome, at least part of the group of users cooperating to do something creative, at least part of the group of users competing within the group, at least part of the group of users cooperating to at least one of solve and overcome a problem, at least part of the group of users competing to at least one of solve and overcome a problem, and at least part of the group of users participating in an at least partially guided conversation. The group activity may, however, include any suitable activity, structure, or other interaction.

Users are preferably put into groups with other users that share commonalities with them, however users are preferably not matched only with users that are automatically determined to be closest to them or have the most in common with them. In one variation of the user selection of the automatic selection algorithm of the first preferred embodiment, users are placed into groups with other users that are automatically determined to both share some commonalities with the user and have some differences with the user. Users, however, can be grouped with other users that are automatically determined to be closest to them, or other users that have any suitable level of automatically determined commonality. In another variation of the user selection of the automatic selection algorithm of the first preferred embodiment, users are shown one or more of: information, characteristics, or pictures of other users, and allowed to indicate which other users that they think they would one or more of: like, dislike, enjoy interacting with, or not enjoy interacting with; these indications from the user are taken into account when selecting a group of users from the pool of users. In another variation of the first preferred embodiment users are given the option to recommend users that another user might enjoy interacting with. A group of users from the pool of users may, however, be selected with any suitable amount of user input or none at all, and a group of users from the pool of users may be selected by any suitable balance of automatic and user driven processes.

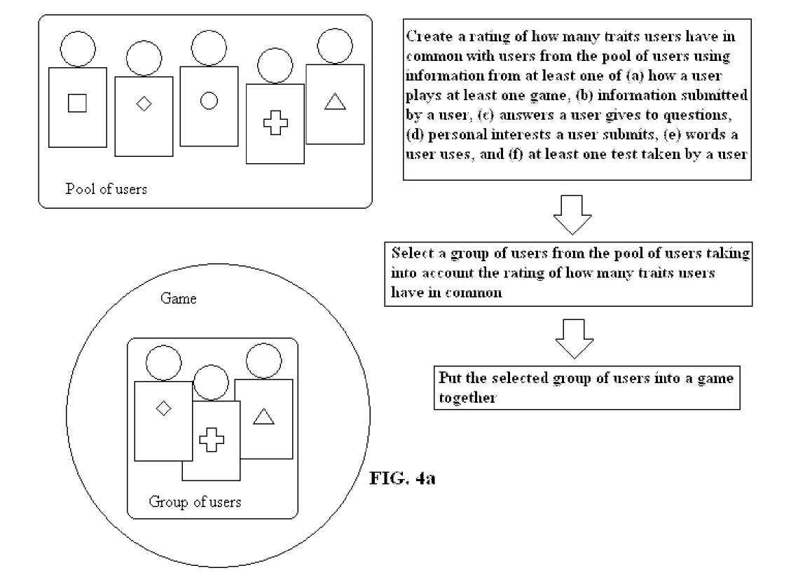

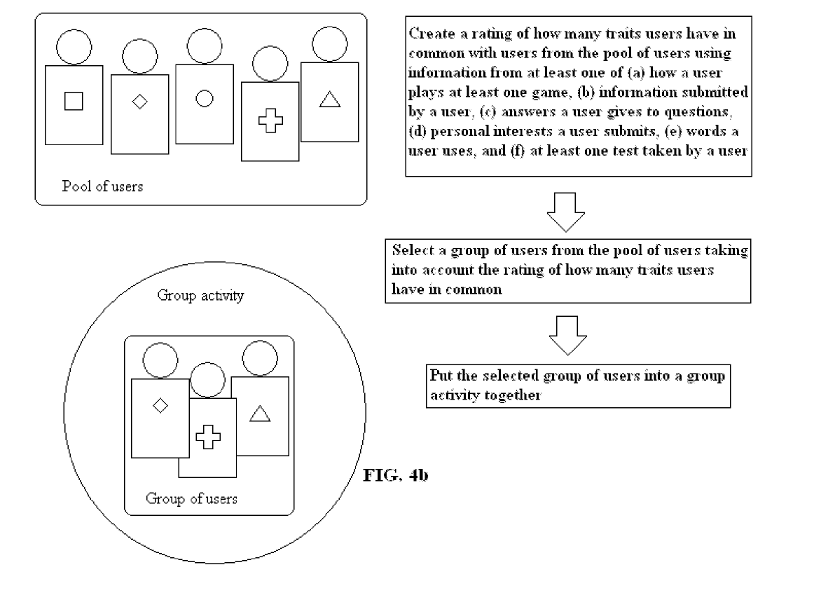

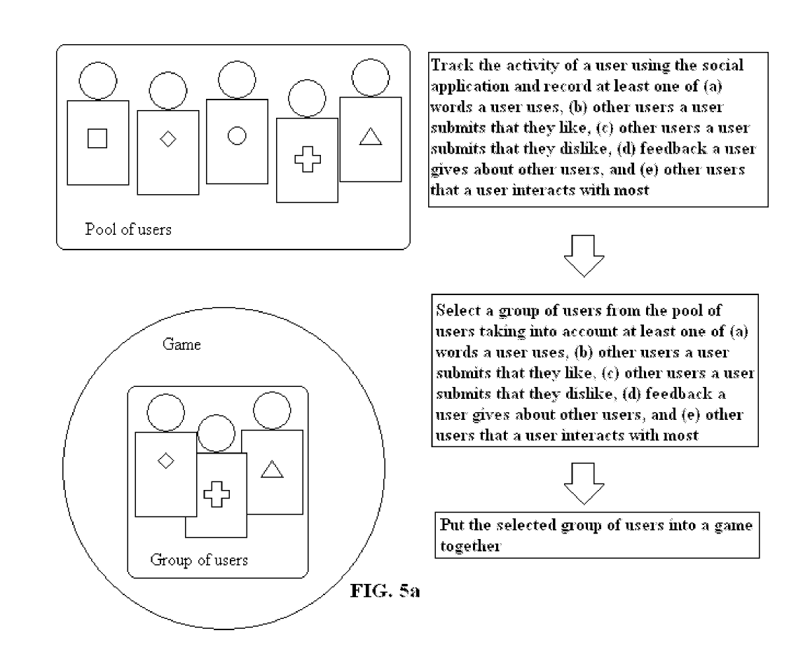

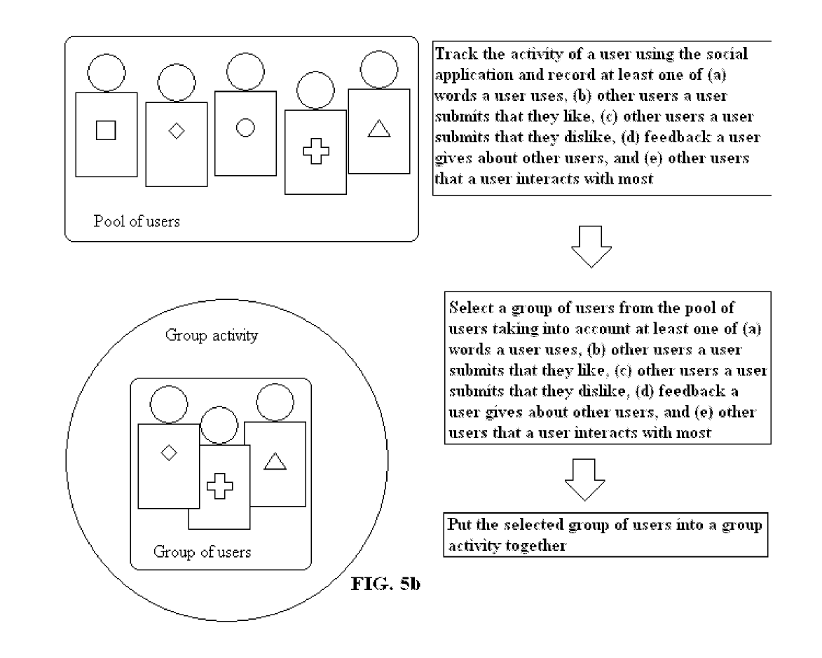

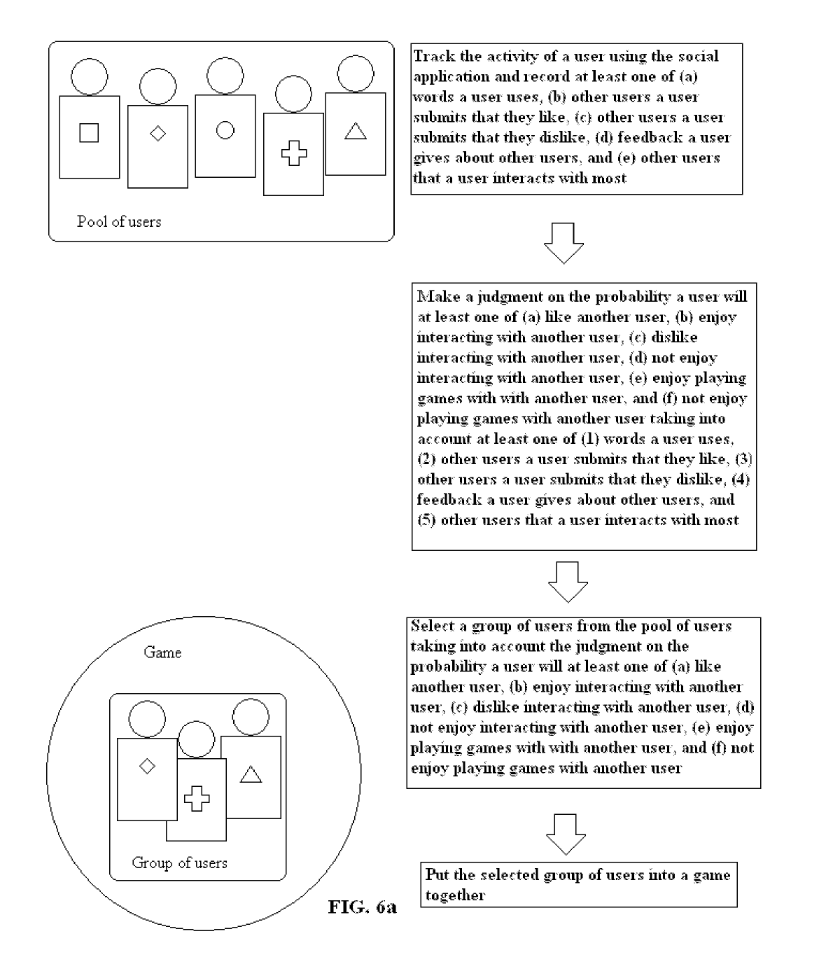

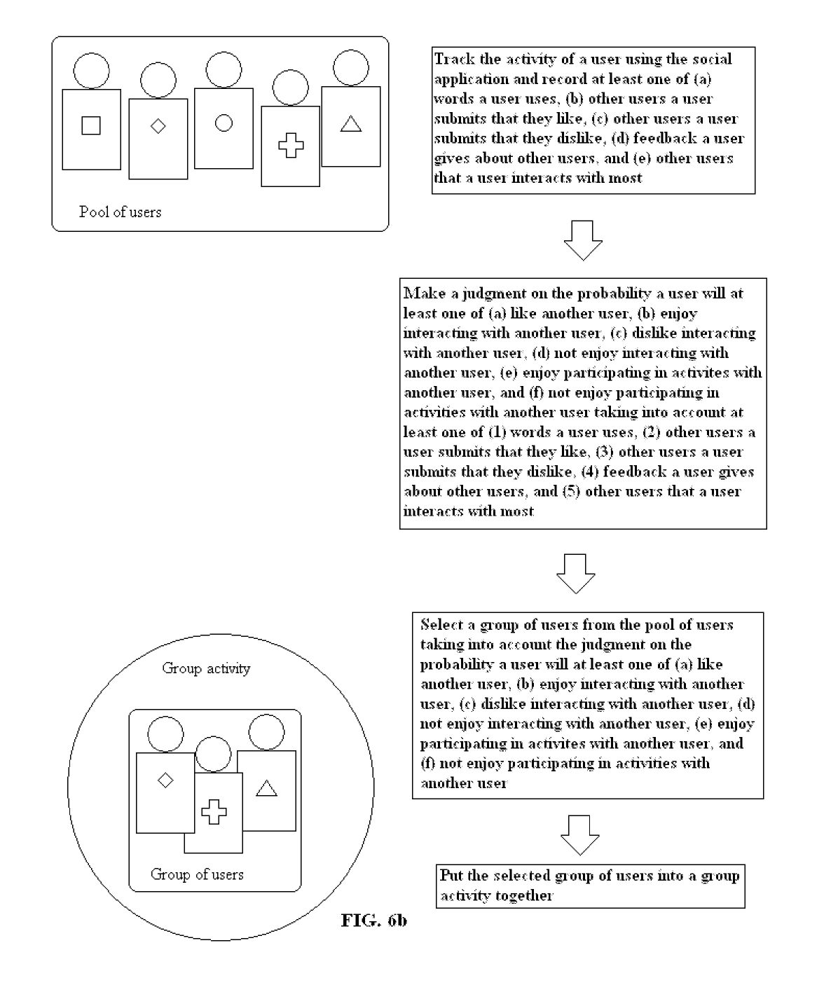

As shown in FIGS. 4a and 4b, preferably the social application creates a rating of how many traits or characteristics a user has in common with other users from the pool of users by taking into account information from one or more of: how a user plays one or more game; information submitted by a user; answers a user gives or has given to questions; personal interests a user submits; words a user uses; one or more test taken by a user. Preferably a group of users is selected from the pool of users taking into account the rating of how many traits or characteristics a user has in common with other users from the pool of users. Preferably the words a user uses are evaluated and classified as one or more of: positive language, love language, sexual language, negative language, and any other suitable classification of language. The words a user uses may, however, be used or evaluated in any suitable manner. As shown in FIGS. 5a and 5b, the social application preferably tracks the activity of a user using the social application and records one or more of: words a users uses; other users a user submits that they like; other users a user submits that they like; other users a user submits that they dislike; feedback a user gives about other users; and other users that a user interacts with the most. In another variation of the user selection of the automatic selection algorithm of the first preferred embodiment, a group of users is selected from the pool of users taking into account one or more of: words a user uses, preferably words that a user uses frequently; other users a user submits that they like; other users a user submits that they dislike; feedback a user gives about other users; and other users that a user interacts with most. As shown in FIGS. 6a and 6b, preferably the social application makes a judgment on the probability a user will one or more of: like another user; dislike another user; enjoy interacting with another user; dislike interacting with another user; not enjoy interacting with another user; enjoy playing games with another user; not enjoy playing games with another user; enjoy participating in activities with another user; and not enjoy participating in activities with another user, this judgment is preferably made by taking into account one or more of: words a user uses; other users a user submits that they like; other users a user submits that they dislike; feedback a user gives about other users; and other users that a user interacts with most. Preferably the social application further takes into account characteristics of other users that a user one or more of: submits that they like, submits that they dislike, gives feedback about, and interacts with the most, and preferably the characteristics the social application takes into account include one or more of: information the other users have submitted, answers the other users have given to questions, words the other users use, who the other users submit that they like or dislike, and who the other users interact with the most. Preferably these characteristics of other users are taken into account when making a judgment on the probability a user will one or more of: like another user; enjoy interacting with another user; dislike interacting with another user; not enjoy interacting with another user; enjoy playing games with another user; not enjoy playing games with another user; enjoy participating in activities with another user; and not enjoy participating in activities with another user. Preferably the social application uses the information on these characteristics to judge what characteristics a user values, does not value, prefers to interact with, prefers not to interact with, does not care about, or any combination of these. In another variation of the user selection of the automatic selection algorithm of the system of the first preferred embodiment, as shown in FIGS. 6a and 6b, a group of users from the pool of users is selected taking into account the judgment made on the probability that a user will one or more of: like another user; enjoy interacting with another user; dislike interacting with another user; not enjoy interacting with another user; enjoy playing games with another user; not enjoy playing games with another user; enjoy participating in activities with another user; and not enjoy participating in activities with another user.

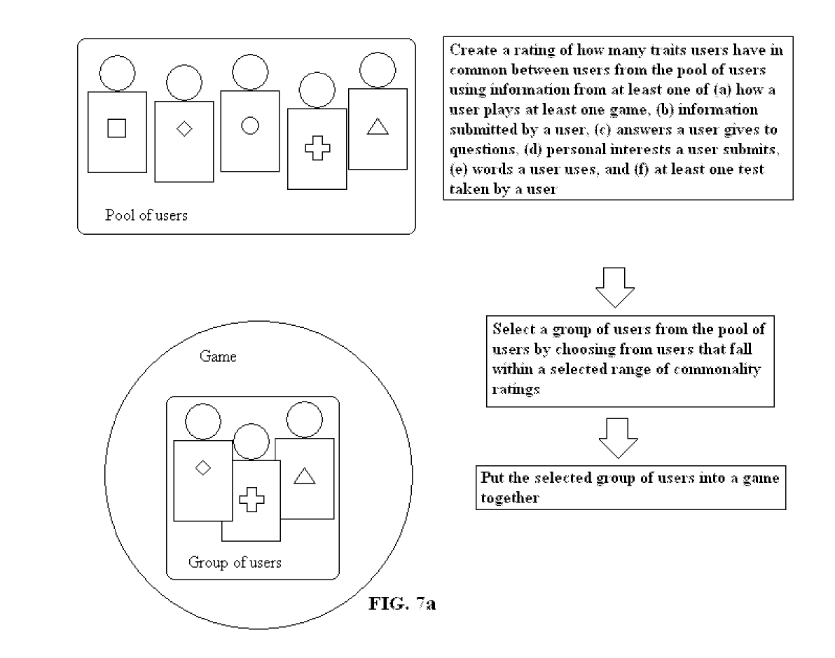

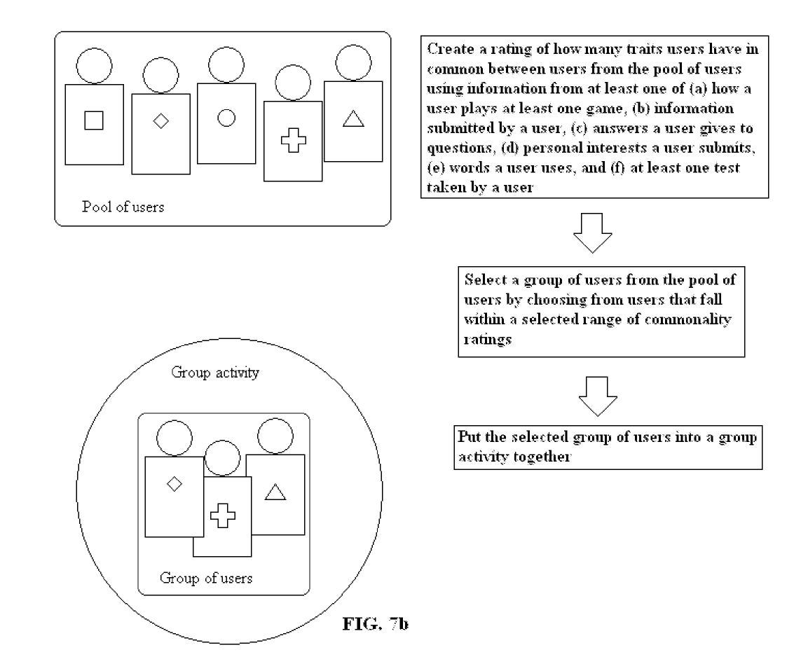

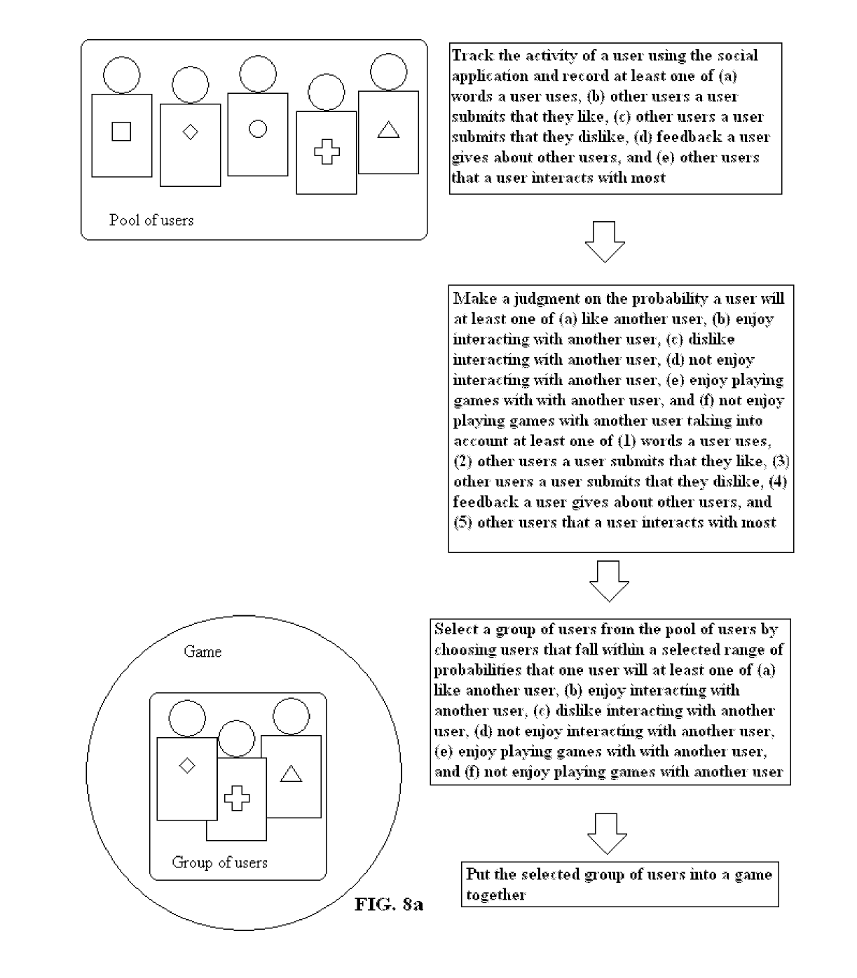

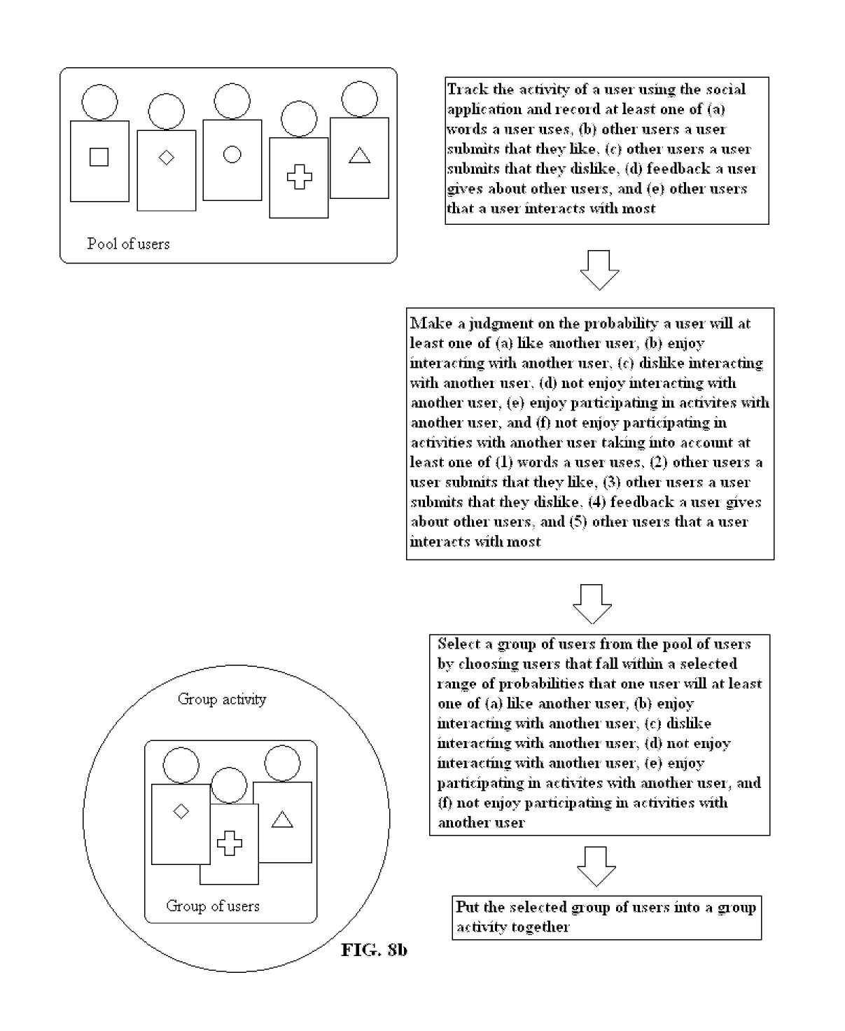

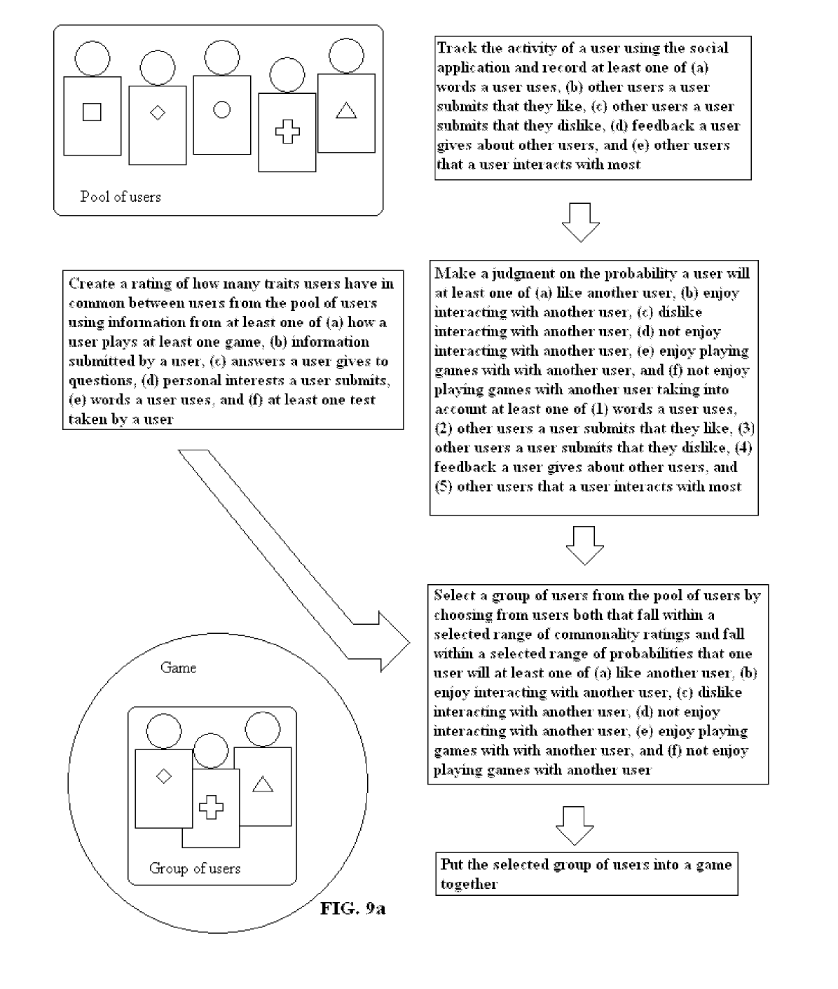

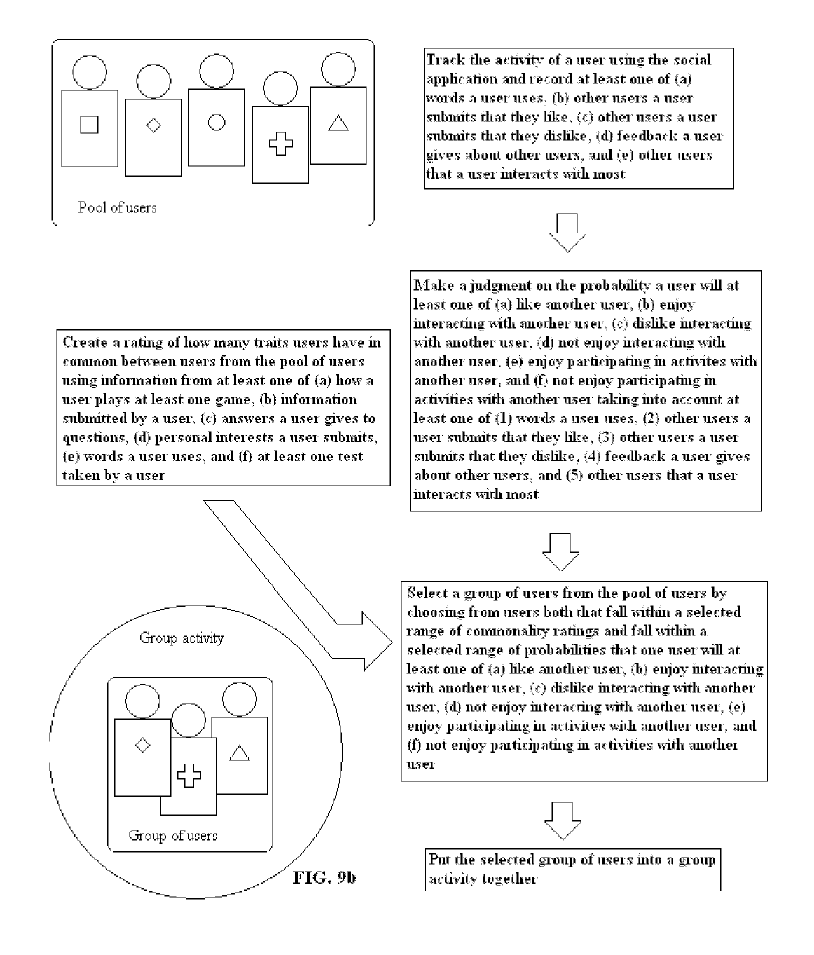

As shown in FIGS. 7a and 7b, preferably a group of users is selected from the pool of users by selecting users from the set of users that fall within a selected range of ratings of how many traits or characteristics a user has in common with other users from the pool of users. Preferably this selected range covers having at least some commonality and less than total commonality, preferably excluding some users at either end of the range of rated commonalities. However, users may be selected with any suitable range of commonality ratings and some users in the selected group of users may be outside the selected range of commonality ratings with one or more users in the group, but in the selected range of commonality ratings with other users in the group. As shown in FIGS. 8a and 8b, in another variation of the user selection of the automatic selection algorithm of the first preferred embodiment, preferably a group of users is selected from the pool of users by selecting users from the set of users that fall within a selected range of judged probabilities that a user will one or more of: like another user; enjoy interacting with another user; dislike interacting with another user; not enjoy interacting with another user; enjoy playing games with another user; not enjoy playing games with another user; enjoy participating in activities with another user; and not enjoy participating in activities with another user. As shown in FIGS. 9a and 9b, preferably users are selected from the pool of users by selecting users from the set of users that both fall within a selected range of ratings of how many traits or characteristics a user has in common with other users from the pool of users and also fall within a selected range of judged probabilities that a user will one or more of: like another user; dislike another user; enjoy interacting with another user; not enjoy interacting with another user; enjoy playing games with another user; not enjoy playing games with another user; enjoy participating in activities with another user; and not enjoy participating in activities with another user. Groups of users may, however, be selected in any suitable manner using any suitable information, characteristics, and relations between information concerning users and with any suitable processes.

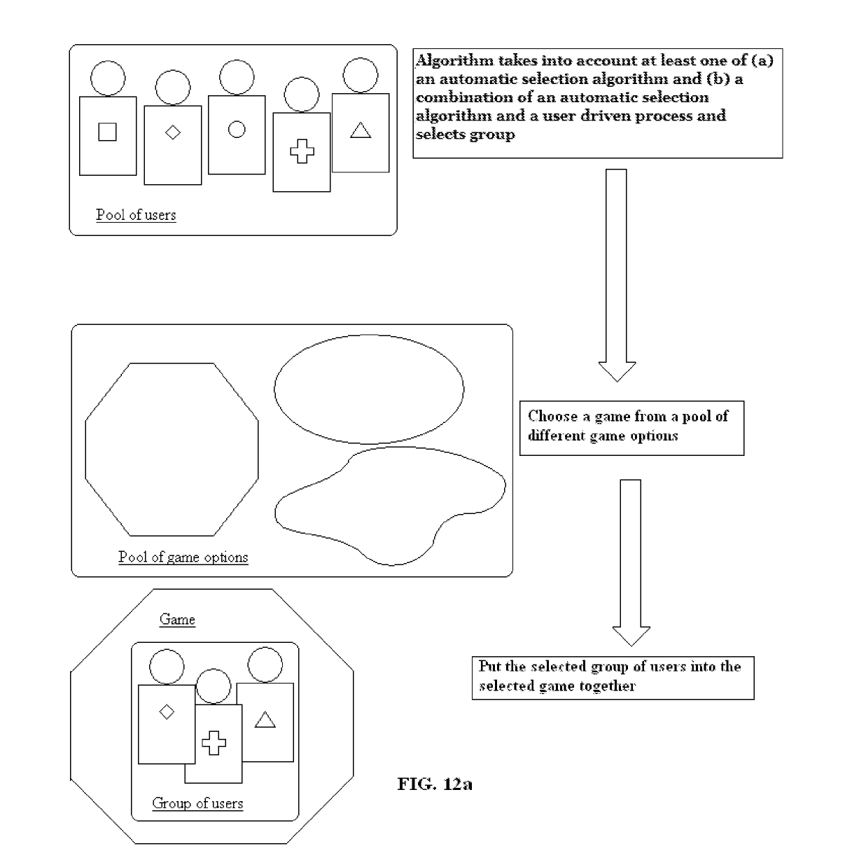

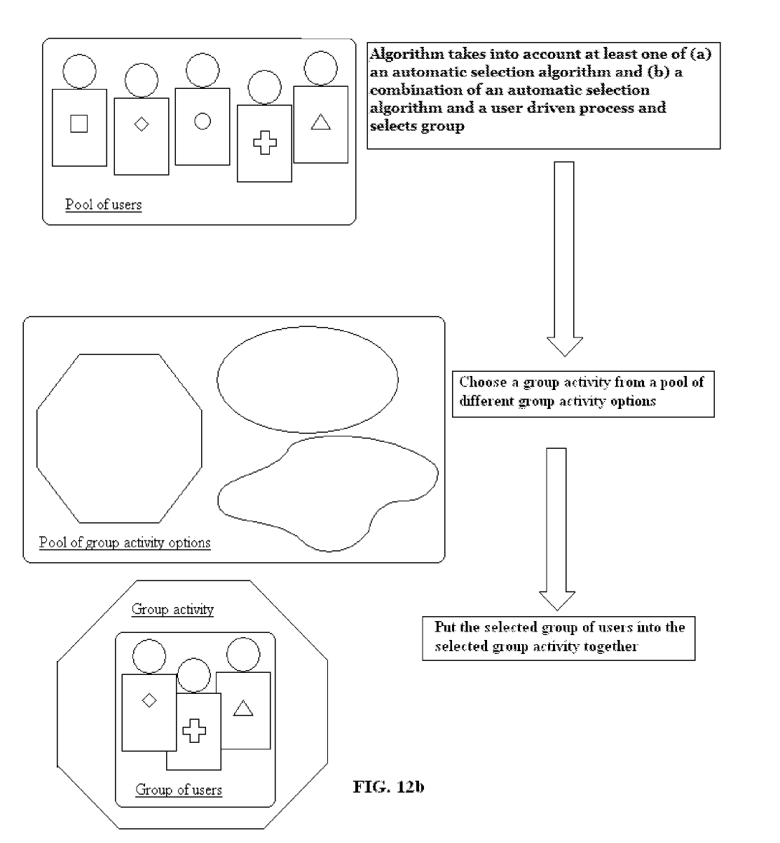

As shown in FIG. 12a, preferably the selected group of users is put into a game selected from a pool of different game options, or, as shown in FIG. 12b, the selected group of users is put into a group activity selected from a pool of different group activity options. Preferably the games in the pool of different game options are chosen or designed to one or more of: encourage users to interact with other users, enable users to get to know other users, make interactions between users enjoyable, and enable users to meet other users they did not previously know, or preferably the group activities in the pool of different group activity options are chosen or designed to one or more of: encourage users to interact with other users, enable users to get to know other users, make interactions between users enjoyable, and enable users to meet other users they did not previously know. In one preferred variation of the games or group activities in the pool of game options or group activity options, the games or group activities involve one or more of: teamwork, interaction between users, communication between users, and competition between users. The games or group activities in the pool of game options or group activity options may, however, involve any suitable structure, any suitable user involvement, and any suitable goal or purpose in the design or selection of the games or group activities.

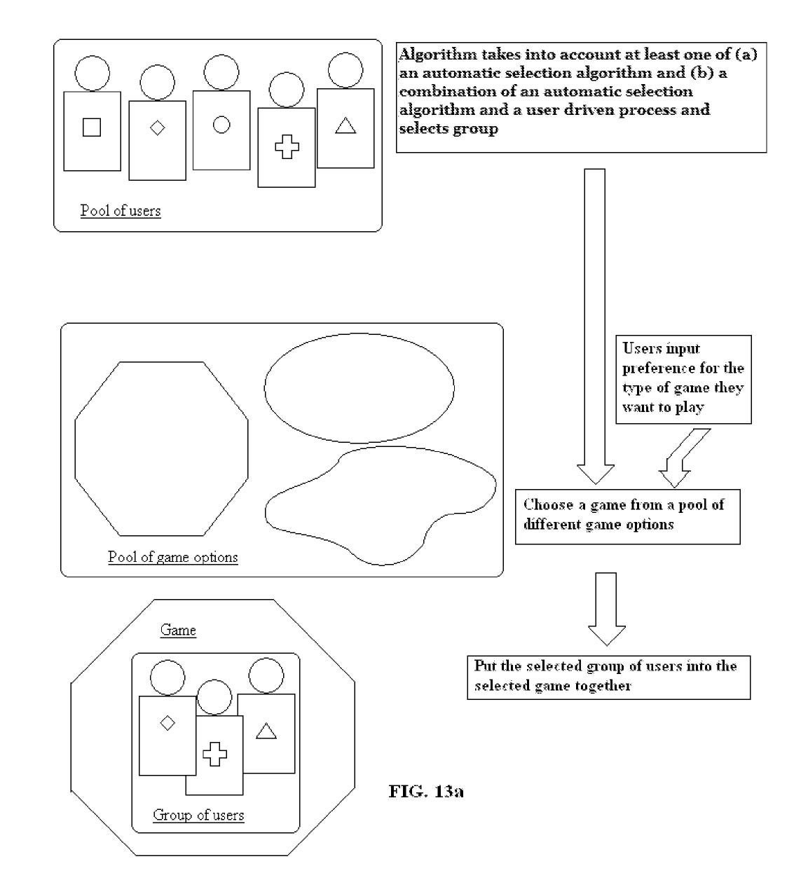

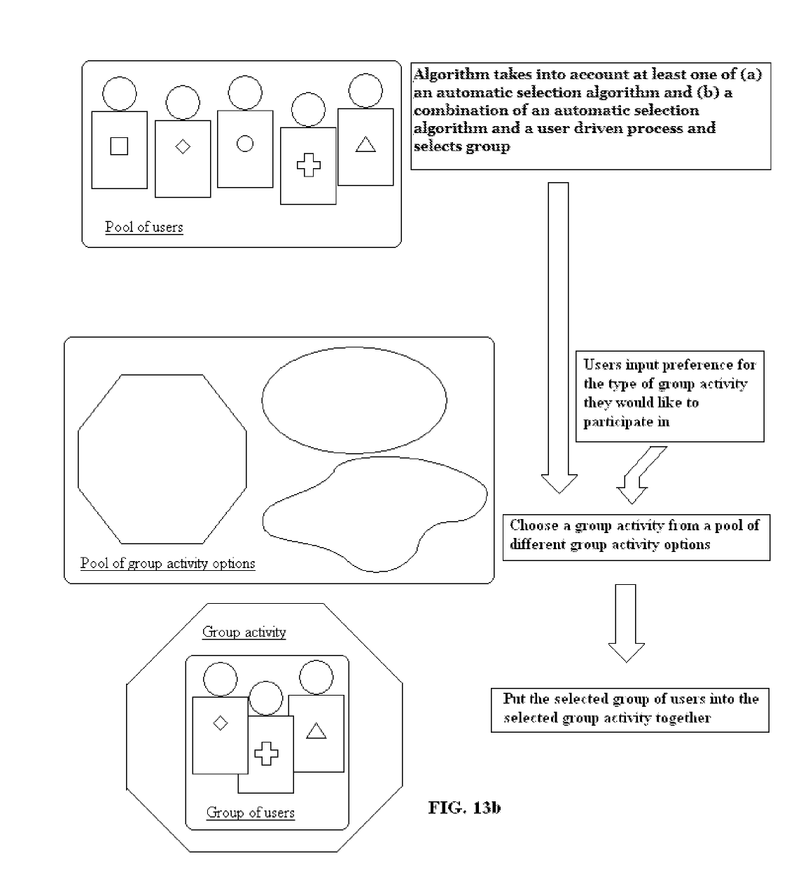

Preferably users are not allowed to select which game or group activity they participate in each time they play. As shown in FIGS. 13a and 13b, preferably users can input a preference for what type of game or type of group activity they would prefer to participate in and the social application takes into account this user input preference when selecting a game or group activity from the pool of game options or group activity options. In one preferred variation of the system of the first preferred embodiment, users are allowed to choose which game or group activity they participate in a fraction of the times that they play a game or participate in a group activity. In another variation of the system of the first preferred embodiment, users select the game or group activity they participate in each time they participate in a game or group activity. The users may, however, have any suitable role in the selection of the games or group activities they participate in, or no role at all.

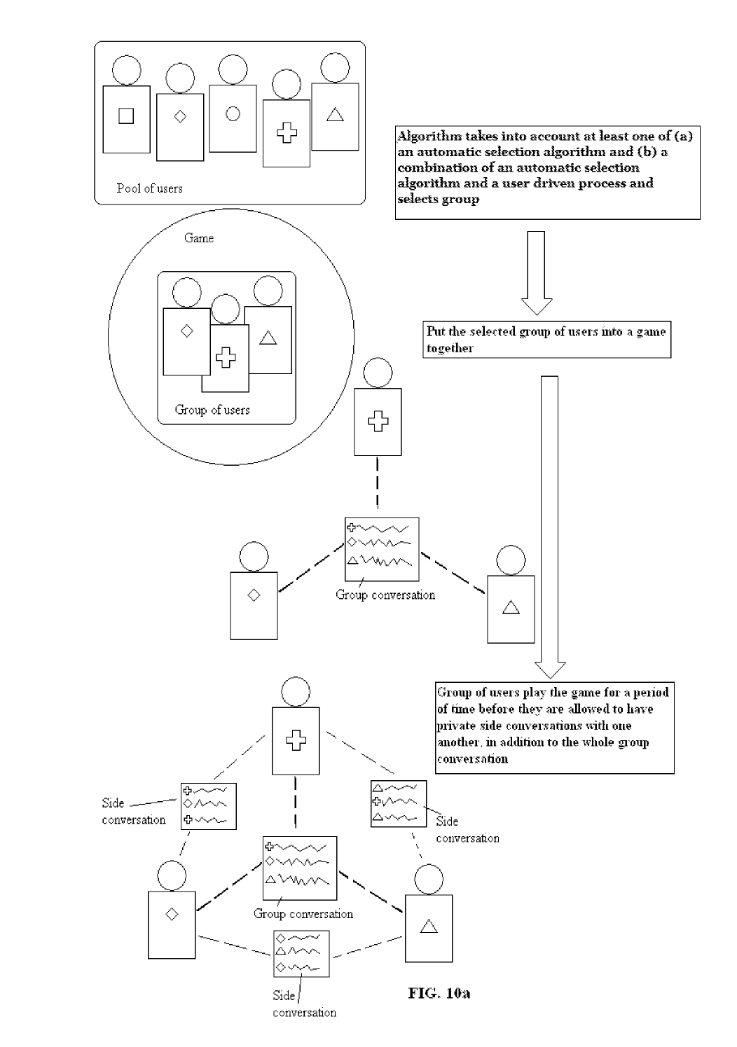

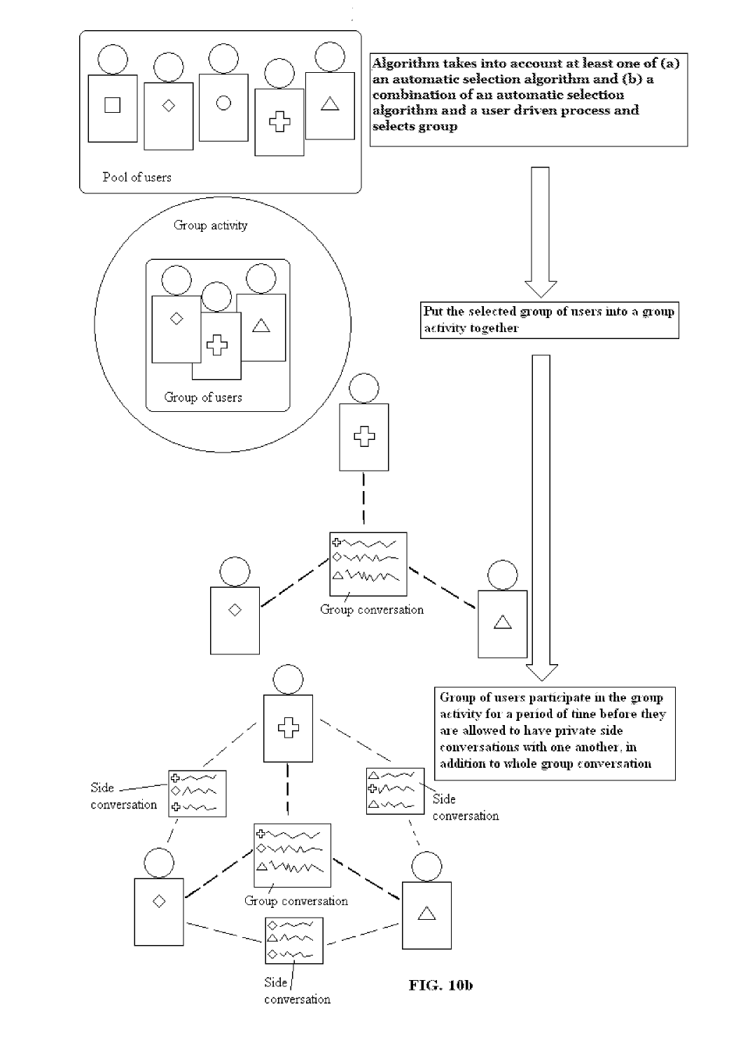

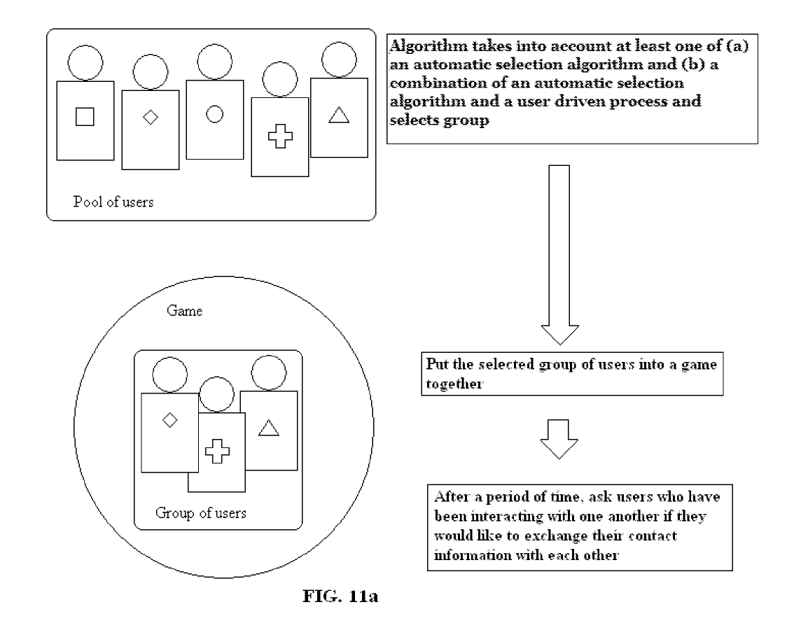

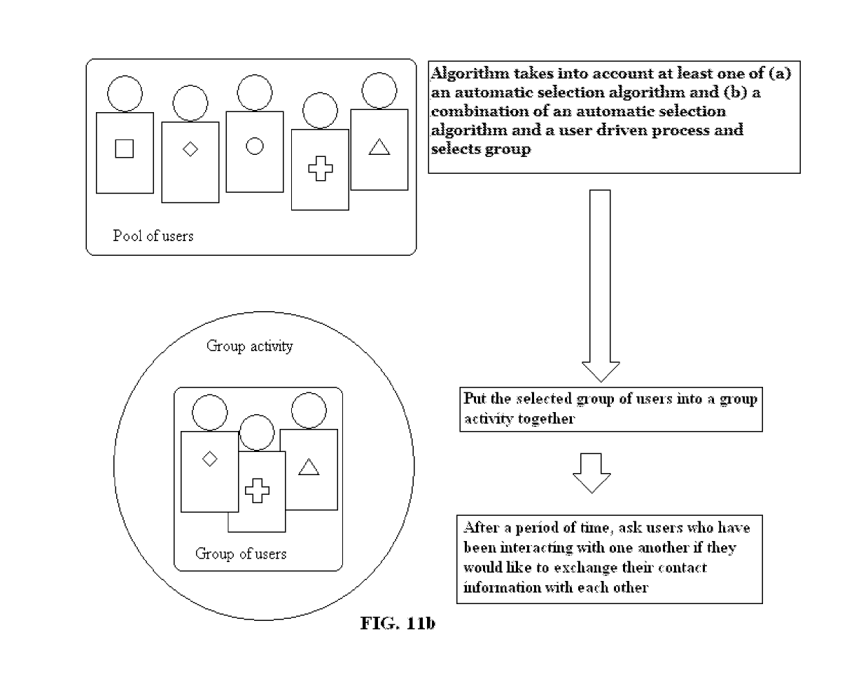

Preferably, as shown in FIGS. 10a and 10b, there is a provision for the users to have a conversation as a group, but the users are not provided with any provisions to have side conversations with one or more of the other users, but not with all of the users in the group, until after the users have interacted and participated in the group activity or game for a period of time. Preferably the period of time is set in advance or is determined by taking into account how the users are interacting. In a variation of the system of the first preferred embodiment, the users are given provisions to have both a group conversation and any number of side conversations with any one or more of the other users in the group from the beginning of their participation in the game or group activity. However, the users may be provided with any suitable provisions for interacting with other users, conversing with other users, or both. The users may be allowed to converse, interact, or both, with any suitable number of the other users in the group at any suitable time. Preferably users are given a way to ask other users if they would like to join a side conversation or interaction. Preferably there is also an automatic selection algorithm for recognizing that users are enjoying interacting with each other, or are conversing with each other in the group conversation, or both, and preferably this automatic selection algorithm asks users if they would like to have a side conversation after they have been enjoying interacting with each other for a period of time, have been conversing with each other in the group conversation for a period of time, or both. In a variation of the first preferred embodiment, after a period of time side conversations are opened between each of the users in the group and the users choose which of the side conversations with the other users they would like to use, or if they would not like to use any of the side conversations. There may, however, be any suitable process for users to establish side conversations or interactions with each other. Preferably users are provided with the option to block or ignore other users that they may decide they do not want to interact with. Preferably, as shown in FIGS. 11a and 11b, after a period of time the social application automatically prompts users to exchange contact information or asks users if they would like to exchange contact information with other users that the social application automatically determines a user has been one or more of: enjoying interacting with for a period of time, having a side conversation or interaction with for a period of time, or indicating that they like or feel favorably about for a period of time; preferably the social application takes into account one or more of: words the users use, the amount of time the users interact in side conversations or interactions with each other, and ratings or feedback the users give to other users when making one or more of these determinations. Preferably users are also given a way to indicate that they would like to exchange contact information with another user. Preferably the social application uses both automatically prompting users to exchange contact information or automatically asking users if they would like to exchange contact information with other users, and allowing users to indicate that they would like to exchange contact information with other users in a manner that suitably makes it difficult for a user to determine if another user indicated that they would like to exchange contact information with a user, or if the social application automatically prompted the user if they would like to exchange information with another user, or automatically asked the user if they would like to exchange contact information with another user. Users may, however, exchange contact information with other users in any suitable manner and at any suitable time, or they may not exchange contact information with other users at all.

Preferably, users are not shown pictures of other users until after they have participated in a game or group activity for a period of time. In a variation of the system of the first preferred embodiment, users are shown pictures of other users participating in the game or group activity with them from the beginning of their participation in a game or group activity. In another variation of the system of the first preferred embodiment, users are not shown pictures of other users at any time by the social application. However, users may be shown pictures of other users at any suitable time.

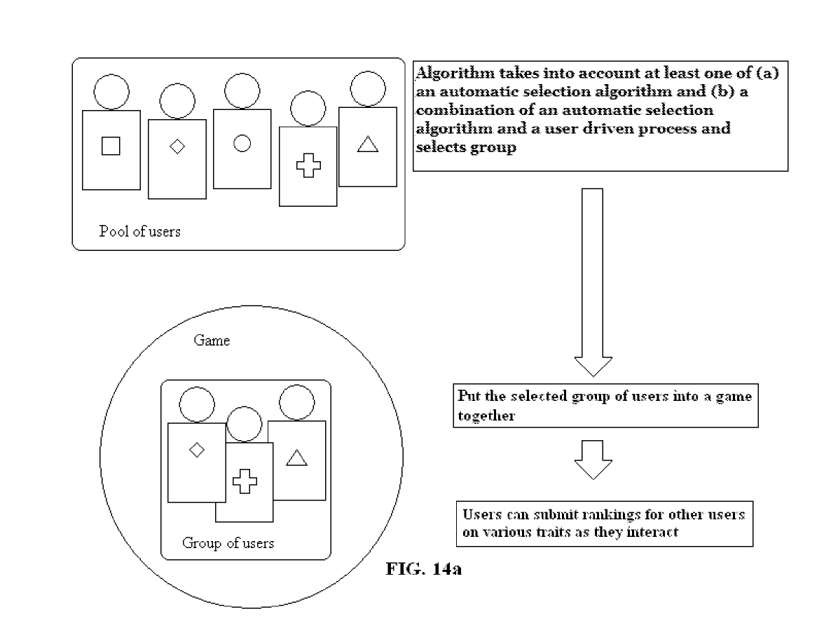

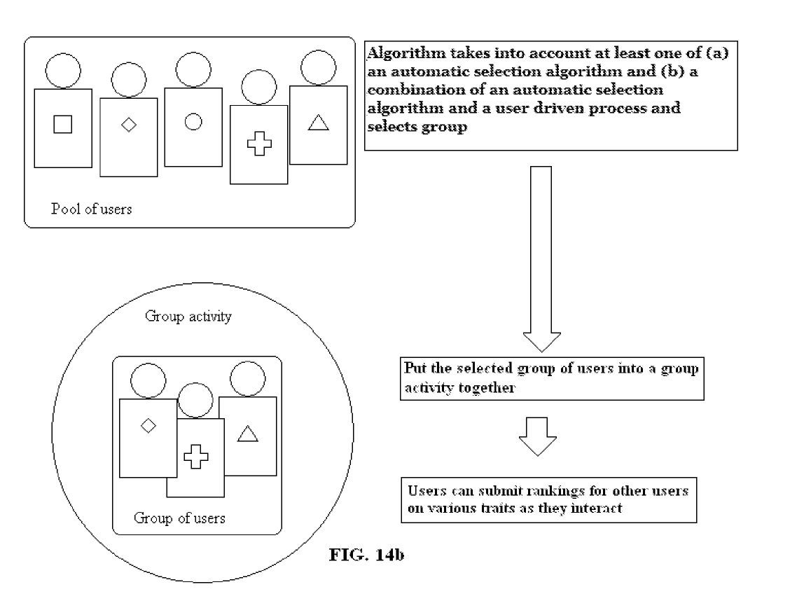

As shown in FIGS. 14a and 14b, users are preferably provided with the ability to rank or rate other users. Preferably users can rank or rate other users on one or more of a group of specified characteristics or traits, preferably including one or more of: funny, interesting, smart, fun, socially intelligent, or any other suitable characteristics or traits. In a variation of the system of the first preferred embodiment, users are allowed to rank or rate other users on any traits or characteristics they choose, including allowing users to submit their own comments or ratings on traits or characteristics the users choose. Users may, however, rank or rate other users on any suitable traits or characteristics, or rank or rate other users in any suitable manner, or users may not rank or rate other users at all. The social application preferably takes into account these rankings or ratings that users give other users when selecting groups of users from the pool of users. Preferably the social application attempts to have at least one user that has been favorably ranked or rated by other users in the past in each selected group of users to improve the group interaction, however any suitable users chosen for any suitable purposes may be included in the selected groups of users.

### 2. Second Preferred Embodiment

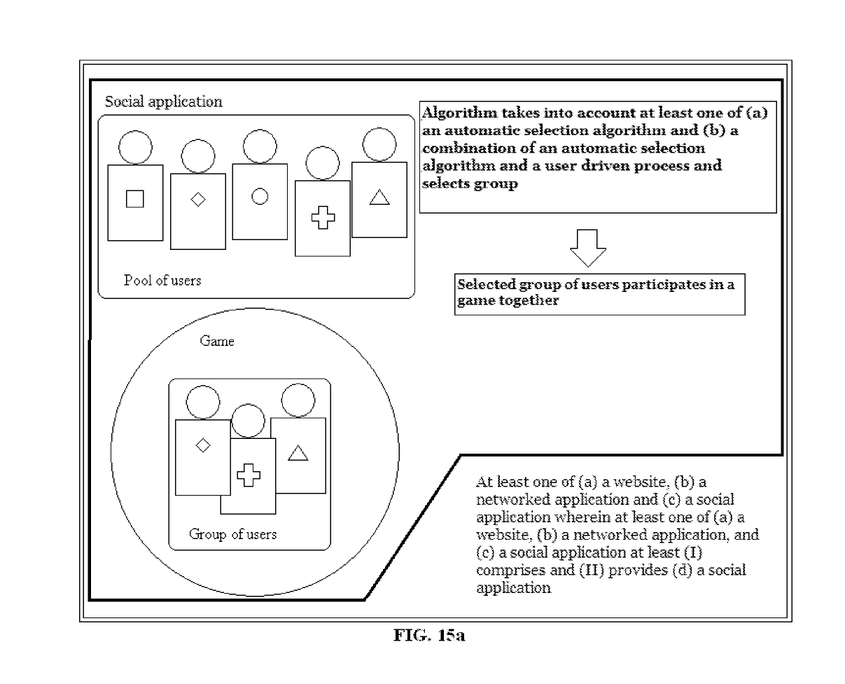

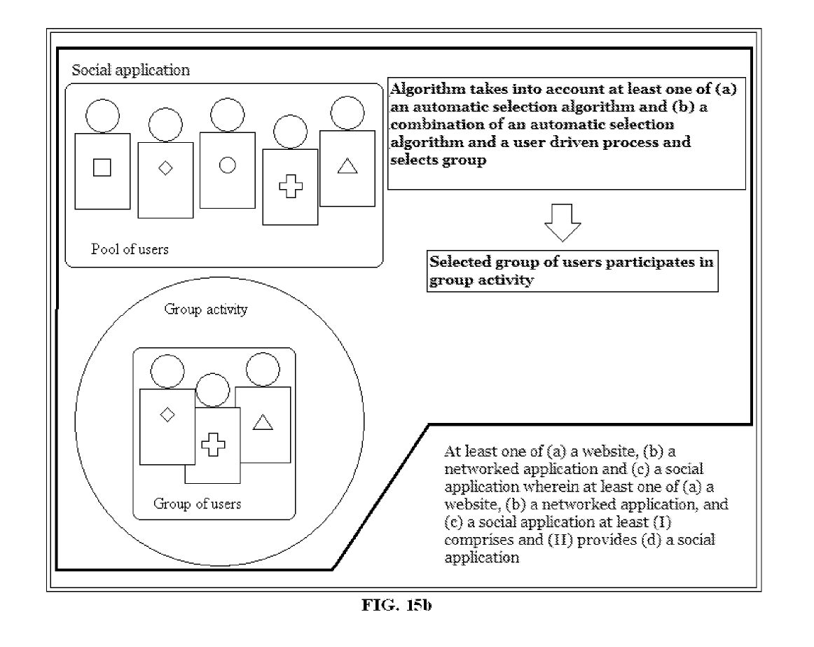

As shown in FIGS. 15a and 15b, the social application of the second preferred embodiments includes at least one of a website, a networked application and a social application that either includes or provides a social application, where that social application includes selecting a group of users from a pool of users using an automatic selection algorithm or a combination of an automatic selection algorithm and a user driven process and putting the selected group of users into a game, as shown in FIG. 15a, or putting the selected group of users into a group activity, as shown in FIG. 15b. The social application of the preferred embodiments is designed to give people an entertaining and structured way to interact, help people meet other people, give people a fun diversion, or any combination of these. The social application of the preferred embodiments may be a website, another application that uses the internet, or any other suitable form of networked application. The social application of the preferred embodiments may, however, be used for any suitable purpose, in any suitable way and with any suitable method of including users.

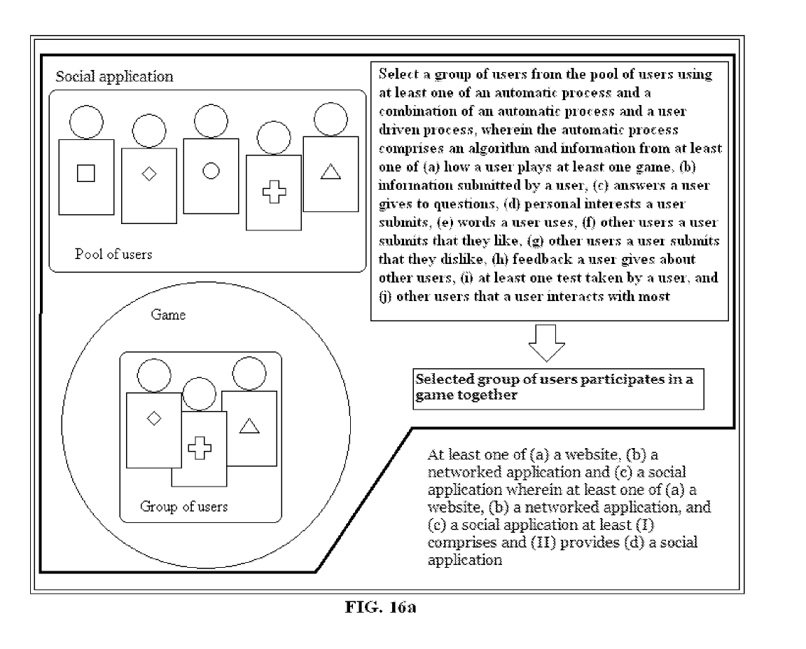

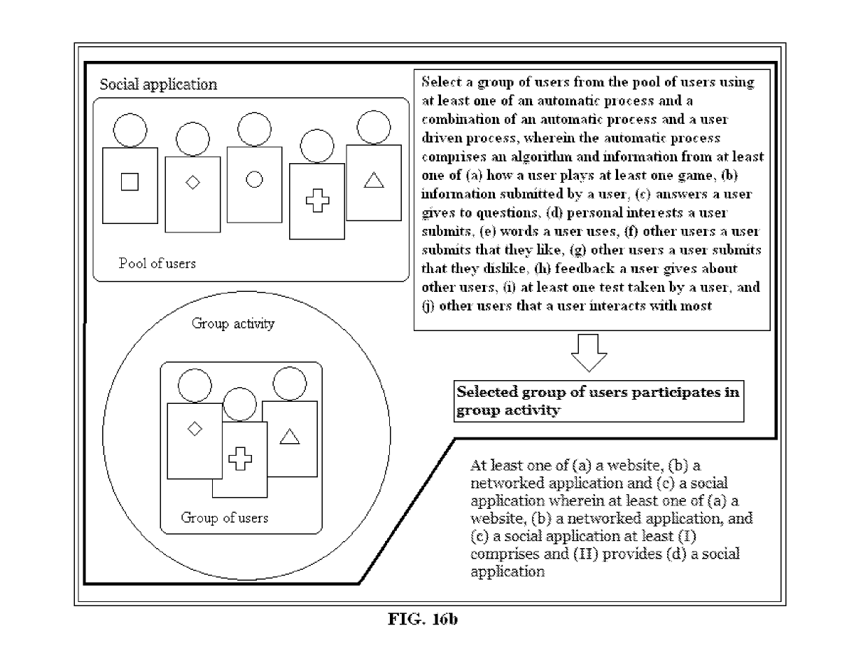

As shown in FIGS. 16a and 16b, the automatic selection algorithm of the second preferred embodiment preferably takes into account at least one of: how a user plays at least one game; information submitted by a user; at least one answer a user gives to at least one question; at least one personal interest a user submits; at least two words a user has input into the social application; at least one other user that a user submits that they like; at least one other user that a user submits that they dislike; feedback a user submits about at least one other user; at least one test taken by a user; information on at least one other user a user interacts with more frequently than other users. The automatic selection algorithm preferably uses at least one of these pieces of information to select a group of users that is well suited to achieving positive interactions between users and interactions that suit the goals of the system of the second preferred embodiment. The automatic selection algorithm may, however, take into account any suitable information or characteristics when selecting which users to put into the group of users. Furthermore, the automatic selection algorithm may, however, use the pieces of information it takes into account to select any group of users that satisfy any suitable requirements. The selected group of users is then either placed into a game as shown in FIG. 16a or into a group activity as shown in FIG. 16b. Users are preferably given one or more of: a question or series of questions; a game or games to play, preferably short games; a form or other structure to submit information about themselves or other information relevant to them; a form or other structure to submit their personal interests; or one or more tests. One or more of these are preferably given when the user either signs up to use the social application or first uses the social application, while any of the others can be given to the user at any suitable point. Information or characteristics of the user may, however, be obtained by any suitable manner and at any suitable time.

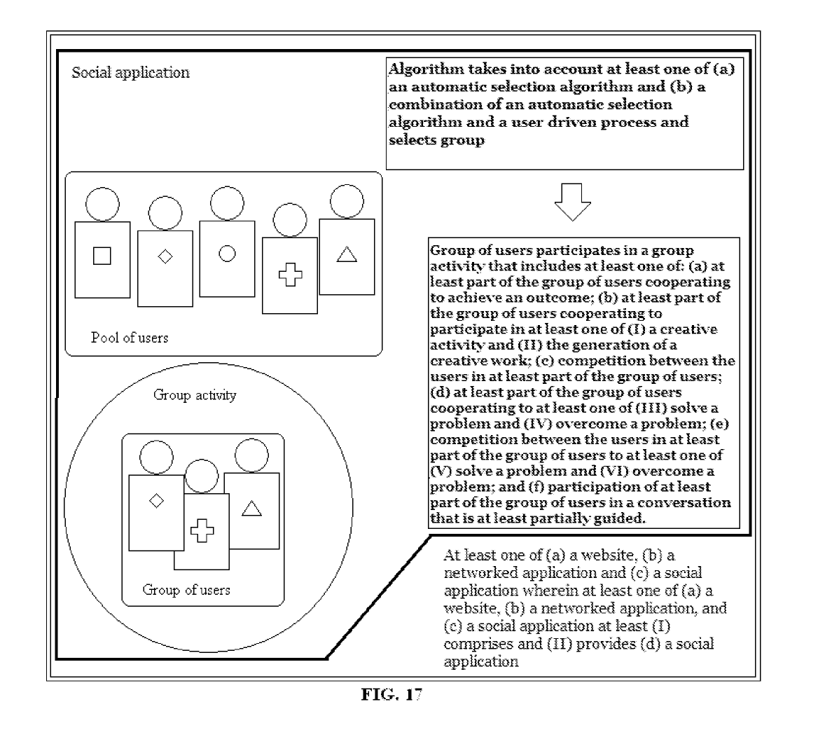

As shown in FIG. 17, the group activity of the second preferred embodiment preferably includes one or more of: at least part of the group of users cooperating to achieve an outcome, at least part of the group of users cooperating to do something creative, at least part of the group of users competing within the group, at least part of the group of users cooperating to at least one of solve and overcome a problem, at least part of the group of users competing to at least one of solve and overcome a problem, and at least part of the group of users participating in an at least partially guided conversation. The group activity may, however, include any suitable activity, structure, or other interaction.

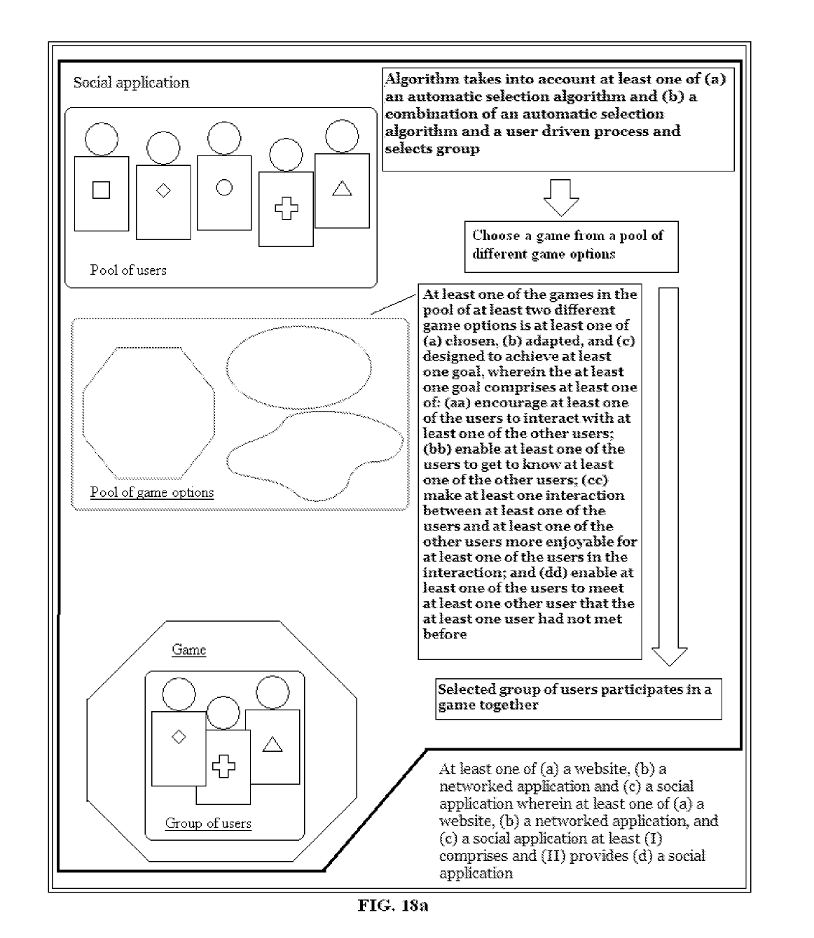

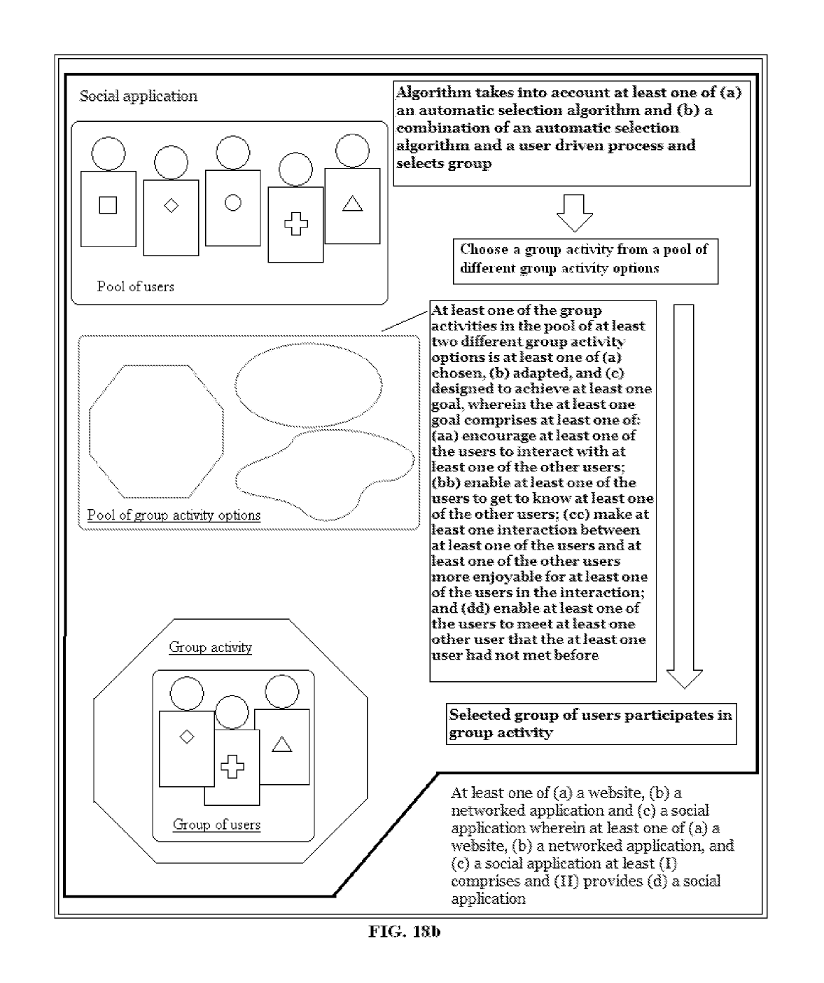

As shown in FIG. 18a, preferably the selected group of users is put into a game selected from a pool of different game options, or, as shown in FIG. 18b, the selected group of users is put into a group activity selected from a pool of different group activity options. Preferably the games in the pool of different game options are chosen or designed to one or more of: encourage users to interact with other users, enable users to get to know other users, make interactions between users enjoyable, and enable users to meet other users they did not previously know, or preferably the group activities in the pool of different group activity options are chosen or designed to one or more of: encourage users to interact with other users, enable users to get to know other users, make interactions between users enjoyable, and enable users to meet other users they did not previously know. In one preferred variation of the games or group activities in the pool of game options or group activity options, the games or group activities involve one or more of: teamwork, interaction between users, communication between users, and competition between users. The games or group activities in the pool of game options or group activity options may, however, involve any suitable structure, any suitable user involvement, and any suitable goal or purpose in the design or selection of the games or group activities.

The other elements of the second preferred embodiment preferably have the same design and function as the similar elements of the first preferred embodiment. The elements of the second preferred embodiment, may, however, have any suitable design and function.

As a person skilled in the prior art will recognize after examination of the previous detailed description and the figures, modifications and changes may be made to the preferred embodiments of the invention without departing from the scope of the invention.

What is claimed is:

1) A social application comprising: a pool of users; an algorithm adapted to select a group of users from the pool of users, wherein a group comprises at least two users, wherein the algorithm is further adapted to take into account at least one of (a) an automatic selection algorithm and (b) a combination of an automatic selection algorithm and a user driven process; and at least one of (c) at least one game and (d) at least one group activity, wherein the group of users participates in at least one of (c) the at least one game and (d) the at least one group activity.

2) The social application of claim 1 wherein the automatic selection algorithm is adapted to take into account at least one of: (a) how a user plays at least one game; (b) information submitted by a user; (c) at least one answer a user gives to at least one question; (d) at least one personal interest a user submits; (e) at least two words a user has input into the social application; (f) at least one other user that a user submits that they like; (g) at least one other user that a user submits that they dislike; (h) feedback a user submits about at least one other user; (i) at least one test taken by a user; (j) information on at least one other user a user interacts with more frequently than other users.

3) The social application of claim 1 wherein the at least one group activity comprises at least one of: (a) cooperation between at least one part of the group of users, wherein the goal of the cooperation is to achieve at least one outcome; (b) cooperation between at least one part of the group of users, wherein the goal of the cooperation is to participate in at least one of (I) a creative activity and (II) the generation of a creative work; (c) competition between the users in at least part of the group of users; (d) cooperation between at least part of the group of users, wherein the goal of the cooperation is to at least one of (III) solve a problem and (IV) overcome a problem; (e) competition between the users in at least part of the group of users to at least one of (V) solve a problem and (VI) overcome a problem; and (f) participation of at least part of the group of users in a conversation that is at least partially guided.

4) The social application of claim 1 wherein the at least one game is selected from a pool of at least two different game options.

5) The social application of claim 1 wherein the at least one group activity is selected from a pool of at least two different group activity options.

6) The social application of claim 4 wherein at least one of the games in the pool of at least two different game options is at least one of (I) chosen, (II) adapted, and (III) designed to achieve at least one goal, wherein the at least one goal comprises at least one of: (a) encourage at least one of the users to interact with at least one of the other users; (b) enable at least one of the users to get to know at least one of the other users; (c) make at least one interaction between at least one of the users and at least one of the other users more enjoyable for at least one of the users in the interaction; and (d) enable at least one of the users to meet at least one other user that the at least one user had not met before.

7) The social application of claim 5 wherein at least one of the group activities in the pool of at least two different group activity options is at least one of (I) chosen, (II) adapted, and (III) designed to achieve at least one goal, wherein the at least one goal comprises at least one of: (a) encourage at least one of the users to interact with at least one of the other users; (b) enable at least one of the users to get to know at least one of the other users; (c) make at least one interact ion between at least one of the users and at least one of the other users more enjoyable for at least one of the users in the interaction; and (d) enable at least one of the users to meet at least one other user that the at least one user had not met before.

8) The social application of claim 4 wherein an automatic selection algorithm selects the at least one game a user participates in.

9) The social application of claim 5 wherein an automatic selection algorithm selects the at least one group activity a user participates in.

10) The social application of claim 4 wherein a user submits a preference for the type of game they would like to participate in, wherein the user submitted preference is at least taken into account by a selection algorithm, wherein the selection algorithm selects the at least one game a user participates in.

11) The social application of claim 5 wherein a user submits a preference for the type of group activity they would like to participate in, wherein the user submitted preference is at least taken into account by a selection algorithm, wherein the selection algorithm selects the at least one group activity a user participates in.

12) The social application of claim 1 wherein at least one user participates in at least one activity, wherein the at least one activity is at least one of: (a) providing answers for at least one question; (b) filling out at least one form, wherein the at least one form is adapted to gather at least one of (I) information about the at least one user and (II) information relevant to the at least one user; (c) filling out at least one form, wherein the at least one form is adapted to gather at least one personal interest of the at least one user; (d) taking at least one test.

13) The social application of claim 12 wherein the automatic selection algorithm is adapted to select a group of users wherein at least two users in the group of users have at least one similarity in the way the at least two users participated in at least one of the activities (a), (b), (c), and (d) of claim 12.

14) The social application of claim 13 wherein the automatic selection algorithm is further adapted to select a group of users wherein at least two users in the group of users have at least one difference in the way the at least two users participated in at least one of the activities (a), (b), (c), and (d) of claim 12.

15) The social application of claim 2 wherein at least one user participates in at least one activity, wherein the at least one activity is at least one of: (a) providing answers for at least one question; (b) filling out at least one form, wherein the at least one form is adapted to gather at least one of (I) information about the at least one user and (II) information relevant to the at least one user; (c) filling out at least one form, wherein the at least one form is adapted to gather at least one personal interest of the at least one user; (d) taking at least one test.

16) The social application of claim 2 wherein the automatic selection algorithm is further adapted to select a group of users wherein at least two users in the group of users have at least one similarity in at least one of (a), (b), (c), (d), (e), (f), (g), (h), (i), and (j) of claim 2.

17) The social application of claim 16 wherein the automatic selection algorithm is further adapted to select a group of users wherein at least two users in the group of users have at least one difference in at least one of (a), (b), (c), (d), (e), (f), (g), (h), (i), and (j) of claim 2.

18) The social application of claim 1 wherein at least one user is shown at least one of: (a) information related to at least one other user, (b) at least one characteristic of at least one other user, and (c) at least one picture of at least one other user, wherein the at least one user is asked to take into account at least one of (a), (b), and (c) and indicate at least one other user that the at least one user thinks thinks they would at least one of: (I) like, (II) dislike, (III) enjoy interacting with, (IV) not enjoy interacting with.

19) The social application of claim 18 wherein the automatic selection algorithm is adapted to take into account the at least one indication of the at least one user.

20) The social application of claim 2 wherein the social application is adapted to generate a commonality rating related to the number of characteristics related to at least one of the categories (a), (b), (c), (d), (e), (f), (g), (h), and (i) from claim 2 that at least one user shares similarities with at least one of the other users in the pool of users.

21) The social application of claim 20 wherein the selection algorithm is further adapted to take into account the commonality rating.

22) The social application of claim 21 wherein the selection algorithm is further adapted to select a group of users wherein at least two users in the group of users have been given a commonality rating that falls within a specified range of values.

23) The social application of claim 2 wherein the social application is adapted to generate a rating related to the probability a user will at least one of: (a) like another user; (b) dislike another user; (c) enjoy interacting with another user; (d) dislike interacting with another user; (e) not enjoy interacting with another user; (f) enjoy playing games with another user; (g) not enjoy playing games with another user; (h) enjoy participating in activities with another user; (i) not enjoy participating in activities with another user, wherein the automatic selection algorithm is further adapted to take into account the rating related to the probability a user will at least one of (a), (b), (c), (d), (e), (f), (g), (h), and (i).

24) The social application of claim 23 wherein the automatic selection algorithm is further adapted to select a group of users wherein at least one user in the group of users has been given a rating related to the probability that the at least one user in the group will at least one of (a), (b), (c), (d), (e), (f), (g), (h), and (i) from claim 23 another of the at least two users, wherein the rating falls within a specified range of values.

25) The social application of claim 1 wherein the social application is further adapted to allow at least one of the users to communicate with at least one of the other users in the group of users while the group of users participates in at least one of (a) the at least one game and (b) the at least one group activity.

26) The social application of claim 25 wherein the social application is further adapted to only allow communication between users in the group of users that is visible to the entire group of users for at least one of (a) a specified amount of time and (b) a period of time until a specified event takes place.

27) The social application of claim 25 wherein the social application is further adapted to provide (a) at least one communication link between users in the group of users wherein the communication is visible to the entire group of users, and (b) at least one communication link that allows at least one user to communicate with at least one of the other users in the group of users, wherein the communication is not visible to the entire group of users.

28) The social application of claim 1 wherein at least one of the users in the group of users is not shown a picture of at least one of the other users in the group of users for at least one of (a) a specified amount of time and (b) a period of time until a specified event takes place.

29) The social application of claim 3 wherein the social application is further adapted to allow at least one user to at least one of (I) rank and (II) rate at least one other user, wherein the automatic selection algorithm is further adapted to take into account the at least one (I) ranking and (II) rating.

30) At least one of (a) a website, (b) a networked application, and (c) a social application wherein the at least one of (a) a website, (b) a networked application, and (c) a social application at least one of (I) comprises and (II) provides (d) a social application, wherein the (d) social application comprises: a pool of users; an algorithm adapted to select a group of users from the pool of users taking into account at least one of (aa) an automatic selection algorithm and (bb) a combination of an automatic selection algorithm and a user driven process; and at least one of (cc) at least one game and (dd) at least one group activity, wherein the group of users participates in at least one of (cc) the at least one game and (dd) the at least one group activity.

31) The at least one of (a) a website, (b) a networked application, and (c) a social application of claim 30 wherein the automatic selection algorithm is adapted to take into account at least one of: (aa) how a user plays at least one game; (bb) information submitted by a user; (cc) at least one answer a user gives to at least one question; (dd) at least one personal interest a user submits; (ee) at least two words a user has input into the social application; (ff) at least one other user that a user submits that they like; (gg) at least one other user that a user submits that they dislike; (hh) feedback a user submits about at least one other user; (ii) at least one test taken by a user; (jj) information on at least one other user a user interacts with more frequently than other users.

32) The at least one of (a) a website, (b) a networked application, and (c) a social application of claim 30 wherein the at least one group activity comprises at least one of: (aa) cooperation between at least one part of the group of users, wherein the goal of the cooperation is to achieve at least one outcome; (bb) cooperation between at least one part of the group of users, wherein the goal of the cooperation is to participate in at least one of (I) a creative activity and (II) the generation of a creative work; (cc) competition between the users in at least part of the group of users; (dd) cooperation between at least part of the group of users, wherein the goal of the cooperation is to at least one of (III) solve a problem and (IV) overcome a problem; (ee) competition between the users in at least part of the group of users to at least one of (V) solve a problem and (VI) overcome a problem; and (ff) participation of at least part of the group of users in a conversation that is at least partially guided.

33) The at least one of (a) a website, (b) a networked application, and (c) a social application of claim 30 wherein at least one of (I) the at least one game is selected from a pool of at least two different game options and (II) the at least one group activity is selected from a pool of at least two different group activity options, wherein at least one of: (III) at least one of the games in the pool of at least two different game options and (IV) at least one of the group activities in the pool of at least two different group activity options is at least one of (aa) chosen, (bb) adapted, and (cc) designed to achieve at least one goal, wherein the at least one goal comprises at least one of: (aaa) encourage at least one of the users to interact with at least one of the other users; (bbb) enable at least one of the users to get to know at least one of the other users; (ccc) make at least one interaction between at least one of the users and at least one of the other users more enjoyable for at least one of the users in the interaction; and (ddd) enable at least one of the users to meet at least one other user that the at least one user had not met before.
